(19) United States
(12) Patent Application Publication
(10) Pub. No.: US 2007/0090133 A1
(43) Pub. Date: Apr. 26, 2007

(54) Actuator cap for aerosol

(75) Inventors: Andrew Macleod, Hertfordshire (GB); Louis Anthony Massari, Surrey (GB)

Correspondence Address: SMITHKLINE BEECHAM CORPORATION;CORPORATE INTELLECTUAL PROPERTY-US, UW2220, P. O. BOX 1539, KING OF PRUSSIA, PA, 19406-0939, US

(73) Assignee: Glaxo Group Limited

(21) Appl. No.: 10/550,884

(22) PCT Filed: Mar. 24, 2004
(86) PCT No.: PCT/EP04/03235

§ 371 Date: Oct. 5, 2006

(30) Foreign Application Priority Data
Mar. 31, 2003 (GB) 0307445.7

(51) Int. Cl. B65D 83/00; B05B 1/14

(52) U.S. Cl. 222/402.13; 239/590.3

(57) ABSTRACT

A dispenser for a foamable composition comprising a pressurized container containing the foamable composition and having a valve with an actuator mounted on the container. The actuator comprises a flow conduit mated with the valve stem and which is displaceable upon the application of actuating force to the actuator to bear upon the valve stem to actuate the valve stem with a closure adjacent to the dispensing opening of the conduit. In the absence of actuating force, the conduit is biased closed against the closure. On the application of actuating force to the flow conduit, the flow conduit is displaced to actuate the valve stem and to be displaced out of its closed relationship with the closure. The actuator can reduce post foaming of the composition.

This invention relates to a novel device for dispensing fluid products from a pressurised container. In particular the invention relates to an actuator device for actuating the valve of a pressurised container.

Household fluids such as shaving foams, hair mousse etc. are often provided contained in a pressurised dispensing container. Such containers have become commonplace and standardised and comprise a container, usually of metal, able to withstand the internal pressure and having a dispensing valve with an exit opening for the fluid. Externally of the container such valves normally comprise a short tube, generally known in the art as the valve “stem” with the exit opening at its end remote from the container, and which can be actuated by application of actuating force to the valve stem.

Generally there are two types of such valve. With a first type of valve the actuating force moves the valve stem along the valve stem longitudinal axis toward the container against a closing bias. With a second type of valve, the so called “toggle” or “tilt” valve, the actuating force moves the valve stem transverse to the valve stem axis toward the container against a closing bias: internally the valve has a mechanism, unrelated to this invention, which responds to such movement to open the valve.

Normally an actuator is fitted to the stem, comprising an operating button, handle or lever etc. which the user can operate to apply actuating force to the valve stem. Normally such an actuator has a part which mates with the valve stem and includes a flow conduit to direct the flow of fluid when it has exited from the valve toward a dispensing opening of the actuator. Often the actuator can be mounted on the pressurised container by for example a snap fit, and often comprises a cover for the valve stem.

Foams may be dispensed from such a pressurised container. Within the container the foam composition includes a propellant, normally a liquefied gas such as butane or propane or a halocarbon. Opening of the valve causes the pressure within the container to drive the foam composition out through the valve stem and through the flow conduit of the actuator. As the propellant meets atmospheric pressure in the valve stem and flow conduit the propellant expands to form numerous small bubbles and so expand the foam. A particular type of such a fluid foam is a foamable dentifrice composition e.g. as disclosed in DE-A-100 08 837, and for example U.S. Pat. No. 3,612,706 discloses a dispensing container for a foamable dentifrice which allows the dentifrice to flow to a toothbrush head.

A problem when dispensing foams in this way from pressurised containers is that when the valve is closed after use a volume of residual foam composition remains within the valve stem and the flow conduit. Propellant remaining in this residual composition expands the residual composition causing it to ooze out of the dispensing opening, resulting in an unsightly mess. This phenomenon is called “post foaming” in the art. Dispensers which address the problem of post foaming are known. EP-A-0699597 discloses a foam dispenser provided with a collecting cavity for residual composition expelled from the dispenser. WO-A-02/48004 discloses a dispenser in which a waste containment region is provided for excess foam. U.S. Pat. No. 5,305,930 discloses a foam dispenser in which a closure, i.e. a poppet valve is positioned immediately the dispensing opening and is opened by the operation of the actuator, trapping excess foam between the closure and the valve of the pressurised container on which it is mounted.

It is an object of the present invention to provide a novel actuator which addresses the problem of post foaming, being simpler than the state of the art and a novel dispenser comprising a container fitted with such an actuator.

According to this invention a dispenser for a foamable composition is provided, comprising,

a container containing the foamable composition under pressure, the container having a valve stem with an exit opening for the composition at its end remote from the container, and which can be moved by application of actuating force to the valve stem to thereby release the composition,

an actuator mounted on said container and by which a user can apply actuating force to the dispensing valve, the actuator comprising,

a flow conduit defining an upstream to downstream flow path for the foamable composition, having a downstream dispensing opening and mated at an upstream end with the valve stem,

the flow conduit being wholly or partly displaceable upon the application of actuating force to the actuator to thereby bear upon the valve stem to actuate the valve stem,

means to communicate actuating force to the flow conduit,

a closure adjacent to the dispensing opening, wherein

in the absence of actuating force the flow conduit is biased into a closed relationship with the closure to obstruct flow of composition through the dispensing opening,

on the application of actuating force to the flow conduit the flow conduit is wholly or partly displaced to actuate the valve stem and the flow conduit is displaced out of its closed relationship with the closure to allow flow of composition through the dispensing opening.

In this description the direction from the valve toward the dispensing opening is termed “downstream” and the opposite direction is termed “upstream”. Normally the dispenser will be operated with the valve stem downwards, i.e. inverted, this being a better orientation for application of a foaming dentifrice to a toothbrush. Normally, to be operated in this inverted orientation the dip tube which is frequently present within such pressurised containers is omitted.

The actuator of the invention works by trapping the residual foamable composition in the flow conduit between the closed valve and the closure when the actuating pressure is released and the flow conduit and closure return under the action of the bias to their closed relationship. This trapped composition can then gradually break down into a small volume of liquid, e.g. as the propellant slowly evaporates and escapes, without oozing through the dispensing opening. Therefore it is preferred that the closure is at or immediately downstream of the dispensing opening so that no composition, or only a minimal quantity of residual composition, resides downstream of the closure when in the closed relationship.

The flow conduit is suitably generally tubular in form, with an internal longitudinal bore along which the composition flows.

In a first embodiment suited to the first type of valve in which the actuating force moves the valve stem along the valve stem axis toward the container against a closing bias, the flow conduit may have a downstream open end and be wholly or partly displaceable along the direction of the stem axis, and the closure may be located adjacent to this downstream open end, so that in its closed relationship the closure obstructs this downstream open end.

By “partly displaceable” or the derivative “partly displaced” is included the meaning that the flow conduit may comprise one or more part conduit, and a part conduit may be displaceable or displaced relative to the other as described herein.

In a first form of this first embodiment the flow conduit may comprise a first part conduit mated with the valve stem, and a second part conduit having a downstream open end, the first part conduit and second part conduit comprising two respective sleeves, with the first part conduit being a conforming sliding fit within the tubular bore of the second part conduit, with the first part conduit being slideably displaceable relative to the second part conduit,

the closure may be adjacent a downstream open end of the second part conduit, so that in the absence of actuating force the first part conduit is biased into a closed relationship with the closure to obstruct flow of composition through the downstream opening, and

on the application of actuating force to the first part conduit the first part conduit is displaced to actuate the valve stem and to displace the first part conduit out of its closed relationship with the closure to allow flow of composition through the dispensing opening.

In a second, alternative, form of this first embodiment the flow conduit may comprise a first part conduit mated with the valve stem, and a second part conduit having a downstream open end, the first part conduit and second part conduit comprising two respective sleeves, with the first part conduit being a conforming sliding fit within the tubular bore of the second part conduit, with the first part conduit being slideably displaceable relative to the second part conduit,

the closure may be adjacent a downstream open- end of the first part conduit, so that in the absence of actuating force the closure is biased into a closed relationship with the second part conduit to obstruct flow of composition through the downstream opening, and

on the application of actuating force to the first part conduit the first part conduit is displaced to actuate the valve stem and to displace the closure out of its closed relationship with the second part conduit to allow flow of composition through the dispensing opening.

Such a relative sliding movement of two such sleeves is commonly known a “telescoping” relationship.

In these forms of the first embodiment the first and second part conduits together comprise the flow conduit. The sliding fit should be such that the respective part conduits make a substantially fluid tight connection. For example preferably the first part conduit may fit slidingly generally coaxial within a tubular bore of the second part conduit and can slide reciprocally along the tubular bore of the second part conduit. Alternatively the second part conduit may fit slidingly generally coaxial within a tubular bore of the first part conduit and can slide reciprocally along the tubular bore of the first part conduit.

Manufacturing tolerances etc. between the closure and the flow conduit allow slow escape of propellant vapour from composition trapped within the flow conduit even when the closure is in the closed relationship. This causes trapped foamable composition to slowly degrade into an insignificant volume of liquid, which evaporates or can be expelled through the dispensing opening when the actuator is next operated. In this way “post foaming” of composition in the flow conduit between the dispensing opening and the valve may be reduced or eliminated.

In a second embodiment suited to the second type of valve in which the actuating force moves the valve stem transverse to the axis of the valve stem, the flow conduit may have a downstream open end and be wholly or partly displaceable in a direction transverse to the direction of the stem axis, and the closure may be located adjacent to this downstream open end, so that in its closed relationship the closure obstructs this downstream open end.

In one form of this second embodiment the flow conduit may comprise a first part conduit mated with the valve stem, and a second part conduit flexibly linked to the first part conduit and having the downstream open end, and the second part conduit may be displaceable in a direction transverse to the direction of the stem axis so that such displacement is communicated to the first part conduit and thereby to the valve stem. For example the second part conduit may be supported in a swivelling manner adjacent to the downstream open end, e.g. by a bearing such as a spherical bearing or a flexible support allowing the displacement. For example the first part conduit may be flexible, e.g. a flexible tube, mated at respectively its upstream end and downstream end with the valve stem and the second part conduit.

In both the first and second embodiments the flow conduit may mate with the valve stem by a tight friction fitting, as is standard in the art, e.g. having an upstream open end with which the valve stem can mate in a male-female manner. Internally the flow conduit may for example have an abutment ledge to abut against the upper end of the valve stem to facilitate the communication of actuating force in the first embodiment from the flow conduit to the valve stem and/or to limit the extent of mating.

In both the first and second embodiments the closure may be located in the flow conduit between the valve and the dispensing opening, but preferably the closure is located at the dispensing opening or immediately upstream thereof so that with the closure closed as much as possible of any residual foamable composition is trapped in the flow conduit upstream of the closure.

The closure may for example comprise any conventional closure system which, in the absence of actuating force operates to close the flow conduit when the flow conduit is biased against the closure.

For example such a system may comprise apertures in the flow conduit which are out of communion in the closed relationship and are brought into communion on displacement of the flow conduit.

For example the closure may comprise a flap or other type of valve in the flow conduit, for example such a valve at the downstream open end of the conduit.

Preferably the closure comprises an obstructer part, and the obstructer part and flow conduit are biased together in the absence of actuating force into a closing relationship and are brought out of this closing relationship on displacement of the flow conduit.

In the first embodiment for example the closure may comprise an obstructer part adjacent to the dispensing opening, against which the downstream open end of the flow conduit may be biased.

For example in the first form of the first embodiment the closure may comprise an obstructer part located adjacent to, e.g. at or immediately upstream or immediately downstream of the downstream open end of the second part conduit, and against which obstructer part the downstream open end of the first part conduit may be biased. The downstream open end of the first part conduit may comprise a seat for such an obstructer part.

For example in the second form of the first embodiment the closure may comprise an obstructer part located adjacent to the downstream open end of the first part conduit, and which may be biased into a closing relationship with the downstream open end of the second part conduit, e.g. against a seat adjacent to this open end.

In the second embodiment for example the closure may comprise an obstructer part, and the conduit is brought out of the closing relationship with the obstructer part as the second part conduit is displaced transverse to the valve stem axis. For example the closure may comprise a closure surface and the second part conduit may have a rim at its downstream open end, which abuts against the closure surface to close the part conduit in the closed relationship and which tilts out of the closing relationship on displacement.

By such a construction the residual foamable composition may be trapped entirely within the flow conduit, e.g. within the first part conduit. Such an obstructer part may for example comprise a conical part engaging in a closing relationship with an end opening of the flow conduit which may be correspondingly conically profiled to provide a seat.

The closure may be made integrally with the flow conduit e.g. with the first or second part flow conduit, or may be provided as a part separate from the flow conduit and assembled with the flow conduit.

The closure and/or the flow conduit may include elastomer compression sealing washer parts to enhance the seal between the conduit and the closure in the closed relationship, for example being compressed between the closure and the flow conduit.

The bias of the flow conduit, e.g. of the first part conduit, into its closing relationship may be provided by a spring, for example biased to urge the flow conduit against the closure in the closed relationship.. Such a spring may for example comprise a metal or plastics material coil spring, for example encircling the flow conduit, for example in the first embodiment encircling the first part conduit, and bearing against an abutment part of the flow conduit and against the container or another part of the actuator. Such a spring may be made of plastics material and may be made integrally with the flow conduit or another part of the actuator. Alternatively such a spring may comprise a resilient elastomer member acting to apply bias by its elasticity. When in the second embodiment the first part conduit comprises a flexible tube this tube may be resilient and may apply a bias resulting from its resilience. Numerous alternative biasing mechanisms will be apparent to those skilled in the art. The valve stem of conventional containers is normally biased closed, and this itself may serve to apply a bias to a flow conduit mated to the valve stem. For example a valve of the first type mentioned above is normally biased to apply a biasing force in the downstream direction.

Preferably the actuator is mounted on the container by a snap or friction fit engagement with the container, which is standard in the art, many pressurised containers being made with a convenient ridge, groove etc. to enable such a snap fitting. For example the actuator may comprise a support which can be mounted on the container in such a manner to support the flow conduit with its upstream end mated with the valve stem. Such a support may also resiliently support all or part of the flow conduit, and thereby resiliently bias the flow conduit and closure together into their closed relationship. Alternatively a resilient biasing means may bear on such a support. Suitably for example such a support may comprise or be engageable with a cover part for the part of the container that includes the valve stem. Such a support may for example have a part defining the dispensing nozzle. For example a second part conduit may be integrally made with or engaged with the support. Numerous other constructions will be apparent and may be based on aesthetic considerations.

Numerous means will be apparent to those skilled in the art by which a user may apply actuating force to the actuator, so that such force is communicated to the flow conduit. For example a handle, lever or button part may extend through for example an aperture in a cover part of the actuator, to which the user may apply actuating force and which bears upon the flow conduit, e.g. upon the first part conduit of the first embodiment, so that the actuating force which is then transmitted to the flow conduit. Such a means may also be the means by which the bias is applied to the flow conduit to bias it into the closing relationship with the closure, for example by a biasing means applying its bias to the means by which a user applies actuating force to the actuator, and this bias being communicated to the flow conduit. Such a means may be made integrally with the flow conduit, first part conduit, and/or support. Handles, levers and buttons of this general type are well known in the actuator art.

The actuator may be made of plastics materials as is common in the art.

The dispensing opening may comprise a conventional nozzle out of which the foamable composition may be dispensed. Alternatively the dispensing opening may comprise an applicator for the composition. For example if the foamable composition is a foamable dentifrice composition the dispensing opening may comprise part of a toothbrush head, in a manner analogous to U.S. Pat. No. 3,612,706.

The invention also provides an actuator mountable on a container containing a foamable composition under pressure, the container having a valve stem with an exit opening for the composition at its end remote from the container, and which can be moved by application of actuating force to the valve stem, and by which a user can apply actuating force to the dispensing valve,

the actuator comprising,

a flow conduit defining an upstream to downstream flow path for the foamable composition, having a downstream dispensing opening which can be mated at an upstream end with the valve stem,

the flow conduit being wholly or partly displaceable upon the application of actuating force to the actuator to thereby bear upon a mated valve stem to actuate the valve stem,

means to communicate actuating force to the flow conduit,

a closure adjacent to the dispensing opening, wherein

in the absence of actuating force the flow conduit is biased into a closed relationship with the closure to obstruct flow of composition through the dispensing opening,

on the application of actuating force to the flow conduit the flow conduit is wholly or partly displaced to actuate a mated valve stem and the flow conduit is displaced out of its closed relationship with the closure to allow flow of composition through the dispensing opening.

Embodiments and preferred features of such an actuator are as described above.

The construction and operation of the device of this invention will now be described and illustrated by way of non limiting example with reference to the accompanying figures which show.

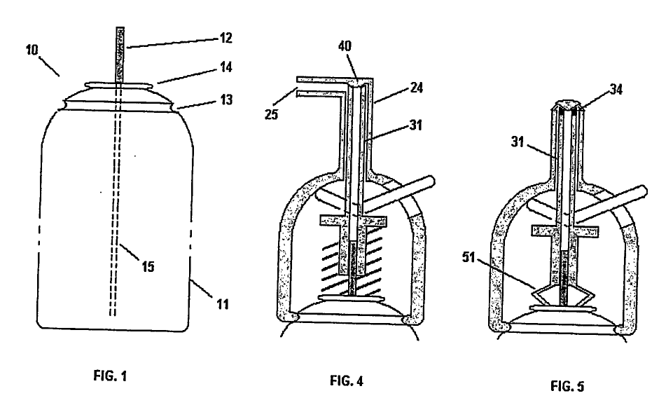

FIG. 1 a typical pressurised container.

FIG. 2 the container of FIG. 1 fitted with an actuator in a closed relationship.

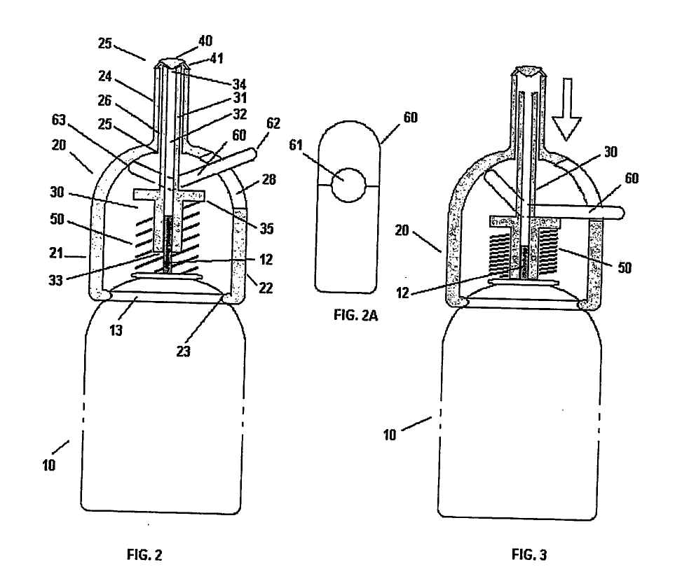

FIG. 3 the container of FIG. 1 fitted with an actuator in an open relationship.

FIG. 4 an alternative construction of actuator.

FIG. 5 an alternative construction of actuator.

FIG. 6 an alternative construction of actuator.

FIG. 7 an alternative construction of actuator.

FIG. 8 an alternative construction of actuator.

FIG. 9 an alternative construction of actuator.

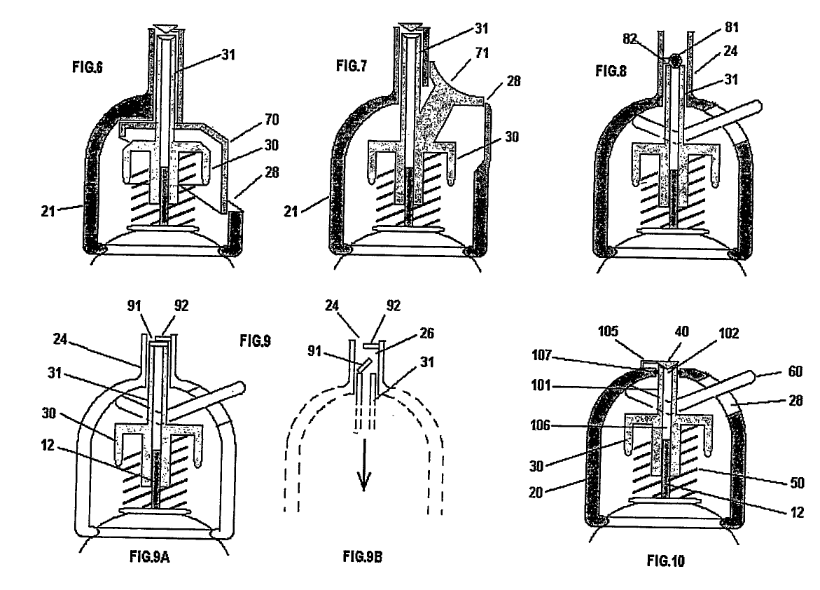

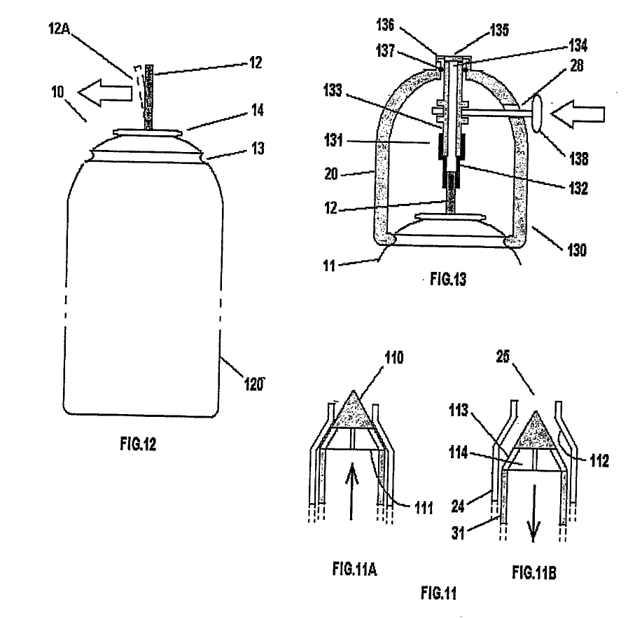

FIG. 10 an alternative construction of actuator.

FIG. 11 an alternative construction of closure.

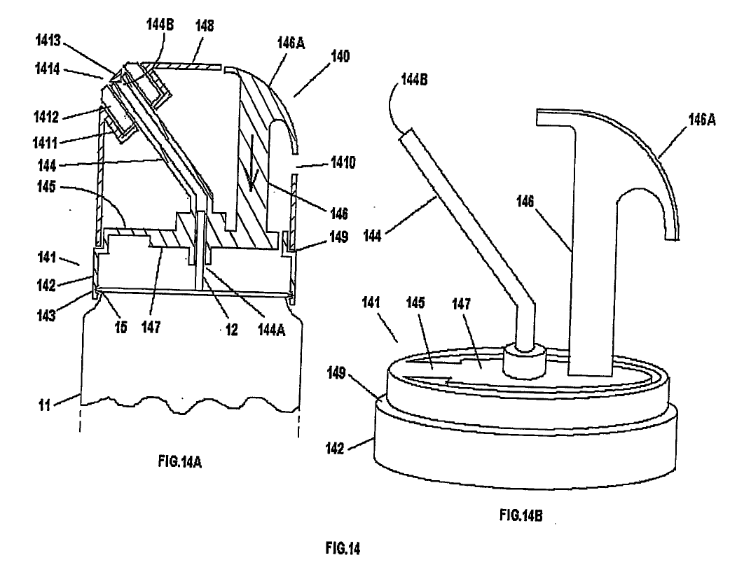

FIG. 12 an alternative form of pressurised container.

FIG. 13 an alternative construction of actuator.

FIG. 14 an alternative construction of actuator.

Referring to FIG. 1 a typical pressurised container 10 is shown overall. The container 10 comprises a cylindrical container 11 provided with a tubular valve stem 12. The valve stem 12 is either of a standard type which is opened by a downward movement toward the container 11 along the longitudinal axis direction of the stem, or an alternative standard type (“toggle valve”) which is opened by a sideways movement of the stem 12. The container 11 is provided externally with an annular groove 13, and an annular ridge 14 around the junction of the valve assembly and the container 11. The container 11 contains a pressurised dentifrice composition (not shown). Internally the container 11 may include a dip tube 15 reaching to near the bottom of the container 11, but which may be omitted if the container is used in its inverted configuration, i.e. with the valve stem 12 downward.

Referring to FIG. 2 an actuator 20 (overall) of the preferred embodiment is shown in longitudinal section mounted onto the container 10.

The actuator 20 comprises a support 21 in the form of a generally bell-shaped cover over the valve stem 12. The support 21 is made of resilient plastics material, and at its lower end is in the form of a cylindrical skirt 22 provided with an internal bead 23 which snap fits into the groove 13. It is equally feasible that the bell shaped part 21 could be made to snap fit around the ridge 14.

The upper part of part 21 narrows to integrally comprise a tubular second part conduit 24 with a dispensing opening 25 at its downstream end. Internally the second part conduit 24 has a cylindrical internal bore 26 terminating at upstream open end 27.

Within the part 21 is a part 30 (overall) which comprises a first part conduit 31 having an internal tubular bore 32. The part conduit 31 has an open upstream end 33 which is able to mate in a fluid-tight fit with the valve stem 12, and an open downstream end 34. Part conduits 24 and 31 together form the flow conduit, so that fluid composition exiting the valve 12 can flow in an upstream toward downstream flow path direction from the valve 12 to the dispensing opening 25 along the bores 26, 32.

The first part conduit 31 and second part conduit 24 are in the form of two telescoping coaxial cylindrical sleeves, the external surface of the first part conduit 31 being a conforming sliding, fluid-tight fit within the tubular bore 26 of the second part conduit 24. The first part conduit 31 may slide reciprocally along the tubular bore 26 of the second part conduit 24 whilst maintaining the fluid-tight seal between them. If necessary a separate sealing means may be provided between the first 31 and second 24 part conduits, e.g. a sealing washer.

Therefore with the cover part 20 attached to the container 11 and the first part conduit 31 mated with the valve stem 12 the part 30 and hence first part conduit 31 can be moved in a sliding manner relative to the second part conduit 24 toward the container 11 to bear upon the valve stem 12 and open the valve. A pressurised composition in the container 11 can then flow through the respective tubular bores 26,32 toward the dispensing opening 25.

A closure 40 is positioned immediately adjacent to the dispensing opening 24. The closure 40 is in the form of a conical obstructer part, positioned with its apex downward, i.e. pointing upstream, so that when the first part conduit 31 is in its most downstream position as shown in FIG. 2 the downstream open end 34 of the first part conduit abuts against the closure 40 to close the first part conduit 31. The closure 40 is supported on small spider legs 41 allowing material from the container 11 to flow between them through the dispensing opening 25.

Around the upstream end of the part 30 is a helical biasing spring 50 which bears expandingly against the upper part of container 11 and an abutment part 35 extending perpendicularly from the upstream-downstream axis direction of the first part conduit 31, to bias the upper open end 34 of the first part conduit 31 in the downstream direction against the closure 40. For example part 35 may be a circular flange surrounding the part conduit 31 or radial spider legs.

Within cover 21 is a bent operating lever 60, which extends through an aperture 28 through the cover 21. Operating lever 60 is shown in a plan view in FIG. 2A, and is seen to have an aperture 61 through which is threaded the second part conduit 31.

As shown in FIG. 3, actuating force may be applied by a user to the part 63 of the lever 60 which extends outside of the aperture 28. This causes the lever 60 to rotate about fulcrum 63 and to communicate this actuating force to the upper surface of abutment part 35 of the part 30. As seen in FIG. 3 this forces the part 30 in the upstream direction (downwardly as shown), compressing spring 50, to both open the valve 12 and to force the closure 40 and end 34 of the first part conduit 31 apart out of their closed relationship to open the dispensing opening 25, allowing fluid content to flow out of the container 11, through the flow conduit 24, 31 and out through the dispensing opening 25.

When actuating force on the lever 60 is released, the spring 50 expands, forcing the part 30 in the downstream (upwardly as shown) direction, allowing the valve 12 to close, and returning the first part conduit 31 into the closed relationship with closure 40 as shown in FIG. 2. This cuts off the flow of the composition, e.g. the foamable dentifrice, at the dispensing opening 25, and also traps a small residual volume of the composition within the first part conduit 31, i.e. between closure 40 and valve 12. This residual composition cannot then escape through dispensing opening 25. Although the fit of the part conduit 31 against closure 40 is substantially fluid-tight, manufacturing tolerances etc. allow slow escape of the propellant vapour from this trapped composition. This causes the trapped foamable composition to slowly degrade into an insignificant volume of liquid, which evaporates or is expelled through the dispensing opening 25 when the actuator is next operated.

FIG. 4 shows an alternative construction of an actuator of the invention in which the second part conduit 24 is bent to deliver material out of dispensing opening 25, and the closure 40 is positioned adjacent the bend. Other alternative constructions will be apparent.

FIG. 5 shows an alternative construction of part 30 in which the helical spring 50 is replaced by plural spring legs 51 integral with the part 30. Alternative constructions of bias spring will be apparent, for example spring legs (not shown) integral with first part, or an elastomer member (not shown) applying bias to part 30.

FIG. 5 also shows the downstream open end 34 of first part conduit 31 provided with a compressible elastomeric sealing washer 36 to enhance the seal with closure 40.

Referring to FIGS. 6 and 7 actuators embodying two alternative ways of enabling actuating force to be applied to the part 30 and first part conduit 31 are shown. In FIG. 6 the part 30 is partly enclosed by a cover 70 which is exposed through aperture 28 in the bell-shaped part 21. Actuating force may be applied to the cover 70, to move cover 70 downwardly relative to the first part 21, and thereby cause the cover 70 to bear upon the part 30 and move second part 30 downwardly, to operate the device in a manner analogous that that described above. In FIG. 7 the part 30 is integrally made into an operating button 71 which is exposed through aperture 28 in the bell shaped part 21, and which a user may depress to move part 30 downwardly, to operate the device in a manner analogous that that described above. Alternative ways of enabling actuating force to be applied to the part 30 will be apparent to those skilled in the art.

Referring to FIGS. 8 and 9, actuators embodying two alternative constructions of closure are shown. In FIG. 8 the closure 81 is located within the second part conduit 24, made integrally with a small fin 82.

In FIG. 9 the closure 91 comprises a flap valve integrally hinged to the rim of the downstream open end of first part conduit 31. As shown in FIG. 9A, with the part 30 biased in the downstream direction, analogous to FIG. 2, the flap 91 abuts against small fin or spider leg 92 projecting across the bore 26 of the second part conduit 24. When as in FIG. 9B the part 30 is moved in the upstream direction in a manner analogous to FIG. 3 the flap 91 is distanced from fin or leg 92 and is opened, for example by the pressure of the composition flowing out of the valve 12 and along the first part conduit 31, and/or by the flap 91 catching on part of the inner surface of second part conduit 24, so that the composition can flow along the part conduits 24,31 and out through the dispensing opening 24.

Referring to FIG. 10 another alternative construction of actuator 100 is shown. The valve stem 12 is again of the type which is opened by movement toward container 11 along the valve stem axis. The actuator 100 overall comprises parts in common with FIGS. 2 and 3 which are numbered correspondingly. In the construction show in FIG. 10 the flow conduit 101 is a one-piece conduit and has a downstream open end 102 which comprises the dispensing opening. The conduit 101 is displaceable along the direction of the stem axis in a manner analogous to the part 30 and first part conduit 31 of FIGS. 2 and 3. A closure 40 analogous to that 40 of FIGS. 2 and 3 is supported on spider legs 105 adjacent to this downstream open end, so that in its closed relationship as shown the closure 40 obstructs the downstream open end 102 of flow conduit 101. When the part 30 and conduit 101 are displaced downwardly by the action of lever 60 in a manner analogous to FIG. 3 the open end 102 is displaced out of the closing relationship with closure 40 to allow composition to flow out of the dispensing opening 102. When actuating force on lever 60 is released the spring 50 returns the conduit 101 to the closed relationship with closure 40, to close conduit 101 and trap residual composition within bore 106 of conduit 101 analogously to the above. An elastomer ring seal 107 may be located between conduit 101 and the rim of an upper opening 108 in part 20 through which conduit 101 extends.

Referring to FIG. 11 an alternative construction of closure is shown, suitable for use with actuators of the types shown in FIGS. 2-9 having a first part conduit 31 which fits in a conforming sliding fit within the bore of a second part conduit 24 having a downstream dispensing opening 25. The closure comprises a conical obstructer part 110, with its apex pointing downstream, located adjacent to the downstream open end 111 of the first part conduit 31. Obstructer part 110 may be biased into a closing relationship with the downstream open end 25 of the second part conduit 24 as shown in FIG. 11A, by seating against a corresponding conical seat 112 adjacent to this open end 25. As shown in FIG. 11B obstructer part 110 may be moved against this bias into an open relationship with the downstream open end 25 of the second part conduit 24, moving away from seat 112. Obstructer part 110 is supported distanced downstream relative to open end 111 by legs 113, with apertures 114 between these legs 113, through which composition may flow in this open relationship.

Referring to FIG. 12 a pressurised container 120 is shown, having a valve 12. of the type in which the valve stem 12 is moved transverse to the axis of the valve stem to open it. FIG. 12 an upright valve closed position and the tilted valve open position 12A. Parts corresponding to the preceding figures are numbered correspondingly.

FIG. 13 shows a construction of actuator 130 suitable for the container 120 of FIG. 12. A flow conduit 131 generally comprises a first part conduit 132 mated with the valve stem 12. First part conduit 132 is flexible, being a flexible tube mated at its upstream end with valve stem 12. The downstream end of part conduit 132 is mated in a fluid tight fit with a second part conduit 133, which is a rigid tubular part conduit having a downstream open end 134. Adjacent to open end 134 is a closure 135 supported on spider legs 136. Closure 135 comprises a closure plate against which the open end 134 is biased into a closed relationship. The flexible tube 132 provides the bias, being made of an elastomer, and may be made in a bellows form to enhance the bias. Second part conduit 133 is displaceable in a direction transverse to the direction of the stem 12 axis so that such displacement is communicated to the first part conduit 132 and thereby to the valve stem 12. This is achieved by supporting the second part conduit 133 in a swivelling manner adjacent to the downstream open end 134 by a flexible support being a ring-shaped elastomeric washer 137 allowing the displacement. Through aperture 28 in the cover 20 extends an operating button 138 which engages with part conduit 133 e.g. by means of a forked end fitting around part conduit 133. When button 138 is moved by pressure applied by a user in the direction shown by the arrow it causes part conduit 133 to tilt so that the seal between end 134 and closure 135 is opened, and at the same time part conduit 132 and hence stem 12 is displaced transverse to the axis of stem 12, thereby opening valve 12 and allowing flow of composition out of container 11 through flow conduit 131 and through open end 134 for use. When pressure on button 138 is released the bias from flexible part conduit 132 returns the conduit 133 to its closed relationship with closure 135, and the bias of the valve stem 12 returns stem 12 to its upright,closed position. Residual composition in flow conduit 131 is trapped between closed valve 12 and closed closure 135, and slowly breaks down without oozing past closure 135.

Referring to FIG. 14 another alternative construction of actuator 140 is shown. FIG. 14A shows a longitudinal section through the actuator 140 and FIG. 14B shows a perspective view of part of actuator 140. The valve stem 12 is again of the type which is opened by movement toward container 11 along the valve stem axis. The actuator 140 comprises a support 141 which has a skirt 142 with an internal groove 143 which engages in a snap-fit manner with a corresponding rim 15 of container 11. Support 141 is made of plastics material e.g. polypropylene, and is integrally made with first part conduit 144, which follows a bent path in its downstream direction, and mates at its upstream open end 144A with valve stem 12. Part conduit 144 is integrally connected to skirt 142 by resilient leaf spring part 145. Also integrally made with skirt 142 is operating button 146. Conduit 144 and button 146 are integrally connected by plate part 147 which is linked to the skirt 142 by spring 145. As shown in FIG. 14A a dome-shaped cover 148 made of plastics material e.g. polypropylene, engages with a seat 149 around support 141 to thereby enclose the conduit 144 and part of button 146. Cover 148 has an aperture 1410 through which the end 146A of button 146 is exposed to be depressed by a user. Cover 148 also incorporates a socket 1411, into which fits a second part conduit 1412 e.g. by screw, friction or snap fit engagement with socket 14i 1. Second conduit 1412 could alternatively be made integrally with cover 148, e.g. linked thereto by a film hinge allowing conduit 1412 to be moved into place. Second part conduit 1412 comprises a sleeve into the bore of which the downstream end 144B fits with a conforming sliding fit. Second part conduit 1412 also incorporates an obstructer part 1413 in the form of a conical part with its apex pointing upstream and supported adjacent the downstream open end 1414 of second part conduit 1412 on spider legs (not shown) analogous to those 41 of FIG. 2. As shown in FIG. 14A spring 145 biases first conduit 144 into a closed relationship with closure 1413.

In use, operating button 146 is depressed in the direction of the arrow by the user applying pressure to end 146A. This consequently causes integral first part conduit 144 to move slidingly in the bore of second part conduit 1412 so that end 144B of first part conduit 144 is moved against the bias of spring 145 out of its closed relationship with closure 1413. At the same time the downward (as seen) displacement of the end 144A of part conduit 144 bears upon valve stem 12 to open the valve 12 and allow composition in container 11 to flow. Part conduit 1412 constrains the pivoting motion of the conduit 144 about spring 145 into linear movement along the bore axis of conduit 1412.

When pressure on end 146A is released, the bias of spring 145 causes integral first part conduit 144 to move slidingly in the bore of second part conduit 1412 so that end 144B of first part conduit 144 is returned to its closed relationship with closure 1413 as shown in FIG. 14A, at the same time allowing valve 12 to close. Propellant slowly evaporates from any composition trapped in part conduit 144 between closure 1413 and valve 12.

1. A dispenser for a foamable composition comprising,
a container containing the foamable composition under pressure, the container having a valve stem with an exit opening for the composition at its end remote from the container, and which can be moved by application of actuating force to the valve stem to thereby release the composition,
an actuator mounted on said container and by which a user can apply actuating force to the dispensing valve, the actuator comprising,
a flow conduit defining an upstream to downstream flow path for the foamable composition, having a downstream dispensing opening and mated at an upstream end with the valve stem,
a flow conduit being wholly or partly displaceable upon the application of actuating force to the actuator to thereby bear upon the valve stem to actuate the valve stem,
means to communicate actuating force to the flow conduit,
a closure adjacent to the dispensing opening, wherein
in the absence of actuating force the flow conduit is biased into a closed relationship with the closure to obstruct flow of composition through the dispensing opening,
on the application of actuating force to the flow conduit the flow conduit is wholly or partly displaced to actuate the valve stem and the flow conduit is displaced out of its closed relationship with the closure to allow flow of composition through the dispensing opening.

2. The dispenser according to claim 1 characterised in that the closure is at or immediately downstream of the dispensing opening.

3. The dispenser according to claim 1 characterised in that the valve is of the type in which actuating force moves the valve stem along the valve stem axis toward the container against a closing bias to thereby open the valve, the flow conduit has a downstream open end and is wholly or partly displaceable along the direction of the stem axis.

4. The dispenser according to claim 3 characterized in that the flow conduit comprises a first part conduit mated with the valve stem, and a second part conduit having a downstream open end, the first part conduit and second part comprising two respective sleeves, with the first part conduit being a conforming sliding fit within the tubular bore of the second part conduit, with the first part conduit being slideably displaceable relative to the second part conduit,
the closure is adjacent a downstream open end of the second part conduit, so that in the absence of actuating force the first part conduit is biased into a closed relationship with the closure to obstruct flow of composition through the downstream opening, and
on the application of actuating force to the first part conduit the first part conduit is displaced to actuate the valve stem and to displace the first part conduit out of its closed relationship with the closure to allow flow of composition through the dispensing opening.

5. The dispenser according to claim 3 characterized in that the flow conduit comprises a first part conduit mated with the valve stem, and a second part conduit having a downstream open end, the first part conduit and second part conduit comprising two respective sleeves, with the first part conduit being a conforming sliding fit within the tubular bore of the second part conduit, with the first part conduit being slideably displaceable relative to the second part conduit,
the closure is adjacent a downstream open end of the first part conduit, so that in the absence of actuating force the closure is biased into a closed relationship with the second part conduit to obstruct flow of composition through the downstream opening, and
on the application of actuating force to the first part conduit the first part conduit is displaced to actuate the valve stem and to displace the closure out of its closed relationship with the second part conduit to allow flow of composition through the dispensing opening.

6. The dispenser according to claim 4 characterized in that the sliding fit is such that the respective part conduits make a substantially fluid tight connection and the first part conduit fits slidingly generally coaxial within a tubular bore of the second part conduit and can slide reciprocally along the tubular bore of the second part conduit.

7. The dispenser according to claim 1 characterized in that the closure comprises an obstructer part, and the obstructer part and flow conduit are biased together in the absence of actuating force into a closing relationship and are brought out of this closing relationship on displacement of the flow conduit.

8. (canceled)

9. The dispenser according to claim 1 characterised in that valve is of the type in which the actuating force moves the valve stem transverse to the axis of the valve stem, the flow conduit has downstream open end and is wholly or partly displaceable in direction transverse to the direction of the stem axis, and the closure is located adjacent to this downstream open end, so that in its closed relationship the closure obstructs this downstream open end.

10. The dispenser according to claim 9 characterised in that the flow conduit comprises a first part conduit mated with the valve stem, and a second part conduit flexibly linked to the first part conduit and having the downstream open end, and the second part conduit is displaceable in a direction transverse to the direction of the stem axis so that such displacement is communicated to the first part conduit and thereby to the valve stem.

11. Dispenser according to claim 9 characterised in that the closure comprises an obstructer part, and the obstructer part and flow conduit are biased together in the absence of actuating force into a closing relationship and are brought out of this closing relationship on displacement of the flow conduit.

12. (canceled)

13. The dispenser according to claim 1 characterised in that the actuator comprises a support which can be mounted on the container in such a manner to support the flow conduit with its upstream end mated with the valve stem, and which also resiliently supports all or part of the flow conduit to thereby resiliently bias the flow conduit and closure together into their closed relationship.

14. The dispenser according to claim 13 characterised in that the support comprises, or is engageable with, a cover part for the part of the container that includes the valve stem.

15. The dispenser according to claim 13 characterised in that the support has a part defining the dispensing nozzle.

16. The dispenser according to claim 13, characterised in that a second part conduit, with the dispensing opening at its downstream end, is integrally made with or engaged with the support.

17. An actuator, mountable on a container containing a foamable composition under pressure, the container having a valve stem with an exit opening for the composition at its end remote from the container, and which can be moved by application of actuating force to the valve stem, and by which a user can apply actuating force to the dispensing valve,
the actuator comprising,
a flow conduit defining an upstream to downstream flow path for the foamable composition, having a downstream dispensing opening which can be mated at an upstream end with the valve stem,
the flow conduit being wholly or partly displaceable upon the application of actuating force to the actuator to thereby bear upon a mated valve stem to actuate the valve stem,
means to communicate actuating force to the flow conduit,
a closure adjacent to the dispensing opening, wherein
in the absence of actuating force the flow conduit is biased into a closed relationship with the closure to obstruct flow of composition through the dispensing opening,
on the application of actuating force to the flow conduit the flow conduit is wholly or partly displaced to actuate a mated valve stem and the flow conduit is displaced out of its closed relationship with the closure to allow flow of composition through the dispensing opening.

18. A method of dispensing a foamable composition comprising providing a dispenser according to claim 1 and applying actuating force thereto to thereby bear upon the valve stem and open the valve stem to thereby cause the foamable composition to be dispensed from the dispensing opening.
